(19) United States
(12) Patent Application Publication
(10) Pub. No.: US 2020/0111121 A1
(43) Pub. Date: Apr. 9, 2020

(54) SYSTEMS AND METHODS FOR AUTOMATIC PROCESSING OF MARKETING DOCUMENTS

(71) Applicant: Socialbakers, a.s., Plzen (CZ)

(72) Inventor: Yuval Ben-Itzhak, Prague (CZ)

(21) Appl. No.: 16/152,000

(22) Filed: Oct. 4, 2018

(51) Int. Cl. G06Q 30/02; G06F 17/30; G06Q 50/00

(52) U.S. Cl. CPC G06Q 30/0254; G06F 17/3053; G06Q 50/01; G06Q 30/0269; G06F 17/30011

(57) ABSTRACT

Methods for processing a marketing document using a natural language processing (NLP) module, identifying; and storing at least one category or topic of words associated with the NLP results and querying a database of existing audience persona profiles for profiles that include at least one of the identified categories or topics are described.

### FIELD OF THE INVENTION

The systems and methods disclosed herein generally relate to the fields of content intelligence and targeted advertising.

### BACKGROUND

The world of marketing has evolved over the years. From the days when estimates to measure reach, engagement and purchase related to the marketing of products were largely unobtainable, the world has moved into a digital era in which digital marketing has greatly improved the accuracy of gauging the effectiveness of targeted marketing, social reach, and product purchase. Digital marketing involves mining data from various sources (e.g., advertisements, social networks, online content and offline content) to learn, plan, execute and measure effectiveness of marketing operations.

Despite the wide adoption of digital marketing, some processes remain ineffective and inefficient. For example, current processes for analyzing marketing campaign briefs are unable to effectively and efficiently identify a target audience for the campaign, what content to use to best engage the target audience, determine the best digital platforms on which to engage with the target audience, determine how much to invest in advertisements to maximize return on investment, determine when to advertise, and identify the potential influencers who can help to reach the relevant audience.

### SUMMARY

Systems and methods for automatically analyzing and processing documents (e.g., documents describing marketing plans, campaign briefs, and product advertisements) to identify persona profiles, influencers, and content that match the campaign are described. These systems and methods can simplify and automate the analysis of a document (e.g., a marketing campaign brief) using natural language processing (“NLP”), identify an audience persona profile towards whom that campaign brief should be targeted, identify content that the identified persona may engage with, identify influencers that share similar interests with the identified persona, recommend targeting criteria for an advertisement, and recommend the best method to reach the target audience. The systems and methods also recommend content elements that can be used to create relevant customer experiences for an audience over digital media channels, based on a given marketing document.

A document processing and management system is provided that receives marketing campaign briefs and, based on analysis and processing of the document, identifies a topic of interest and/or category of products targeted by the campaign and selects persona profiles that best match the topic of interest and/or the category of products targeted by the campaign. For example, persona profiles associated with topics of interest, news feeds, and events that best match the campaign can be identified. Accurate identification and selection of the most suitable persona profiles can help marketers automatically identify suitable persona profiles that best match future marketing campaigns.

The systems and methods described herein are also directed to generating, storing, and using persona profiles. A persona profile describes a typical, but fictional, member of a target audience and can include descriptive fields that represent aspects of the target audience, such as geographic location(s), content subscription(s), events of interest, causes, and demographics of the target audience. The persona profiles can be displayable representations rooted in behavioral data and knowledge that marketers gained from getting to know their product and/or brand supporters.

In some embodiments, the document processing and management system can utilize the persona profiles to identify influencers that have engaged with an audience having interests similar to the identified persona profile(s). Relevant identified influencers may be leveraged as part of a marketing campaign in order to help to reach the relevant audience.

In some embodiments, the document processing and management system can also use the persona profiles to identify content files and/or topics of interest that the selected persona profiles engage with in order to match business and/or marketing objectives of the campaign with the content files and topics of interest of the selected persona profiles. This technique can help identify advertisement topics that will be of interest to the selected persona profile and benefit the campaign objectives.

The systems for automatically analyzing and processing campaign marketing documents can include one or more processors, display screens, communications circuitry, and memory containing instructions. The methods and systems for automatically analyzing and processing campaign marketing documents can include receiving one or more marketing documents from a marketer device associated with the marketing campaign. The one or more marketing documents may be queued for upload to the document processing system.

### BRIEF DESCRIPTION OF DRAWINGS

The above and other aspects and advantages of the invention will become more apparent upon consideration of the following detailed description, taken in conjunction with accompanying drawings, in which like referenced characters refer to like parts throughout, and in which:

FIG. 1 shows an exemplary system in accordance with various embodiments;

FIG. 2 shows an example of a marketing document in accordance with various embodiments;

FIG. 3 shows an example of natural language processing results from a marketing document in accordance with various embodiments;

FIG. 4 shows an example of a schematic illustration of persona profiles in accordance with various embodiments;

FIG. 5 shows an example of a schematic illustration of an influencer profile displaying interests that match with the interests of an identified persona profile in accordance with various embodiments;

FIG. 6 shows an example of a schematic illustration of campaign content that a persona profile is likely to engage with in accordance with various embodiments;

FIG. 7 shows an example of recommended advertisement targeting criteria based on attributes of an identified persona in accordance with various embodiments;

FIG. 8 shows an example of an illustrative flowchart of a process for generating persona profiles, in accordance with various embodiments;

FIG. 9 shows an example of an illustrative flowchart of a process for identifying a persona profile based on analyzing and processing a marketing document and providing content matching services based on the persona profile in accordance with various embodiments.

### DETAILED DESCRIPTION

Systems and methods for automatically processing marketing documents are provided. The present description describes the creation and use of a persona profile database to assist a marketing campaign in identifying characteristics of a target audience likely to be interested in the products or services described in a document, such as a marketing campaign brief. Additionally, by automatically implementing content matching techniques with the persona profile, the methods, systems and computer readable media can recommend to marketers influencers and content satisfying predetermined match criteria and attributes, which can increase effectiveness of current and future marketing campaigns.

It is noted that the terms “device” and “document processing and management system” are used herein to refer broadly to a wide variety of storage devices, natural language processing modules, and document analysis service providers, electronic devices and user devices. It is also noted that the term “content database” is used herein to refer broadly to a wide variety of digital data, documents, text content databases, audio content databases, video content databases, portions of content databases, online data, offline data, and/or other types of data. Content databases may also include files, folders or other mechanisms of grouping content databases together with different behaviors, such as collections of content databases, playlists, albums, etc. The term “user” is also used herein broadly, and may correspond to a single user, multiple users, authorized accounts, an application or program operating automatically on behalf of, or at the behest of a person, or any other user type, or any combination thereof. The term “persona image” is also used herein broadly, and may correspond to profile images captured via one or more image capturing components, continuous images captured, recorded images, or any other type of image that may be captured via an image capturing component, or any combination thereof. The term “influencer” is also used herein broadly, and may correspond to a user with a social media profile of more than approximately 1000 followers.

The present invention may take form in various components and arrangements of components, and in various techniques, methods, or procedures and arrangements of steps. The referenced drawings are only for the purpose of illustrating embodiments, and are not to be construed as limiting the present invention. Various inventive features are described below that can each be used independently of one another or in combination with other features.

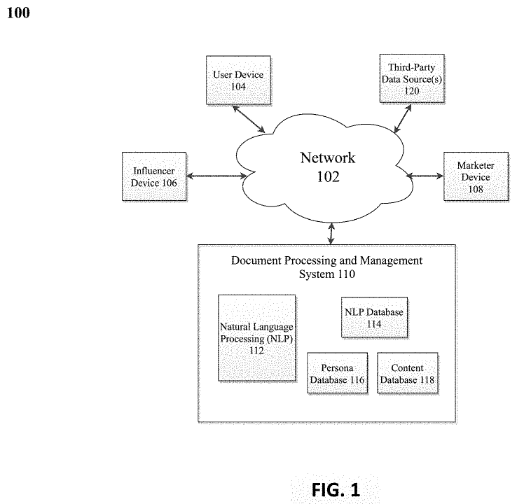

FIG. 1 shows an exemplary document processing system, in accordance with various embodiments. Document processing system 100 includes user device 104, marketer device 106, and influencer device 108, each of which is communicatively coupled to network 102. Network 102 may be any network, combination of networks, or network devices that may carry data communication. For example, network 102 may be the Internet or one or a combination of LANs (local area networks), WANs (wide area networks), telephone networks, wireless networks, point-to point networks, star networks, token ring networks, hub networks, etc. Document processing and management system 110 includes, or is communicatively coupled via network 102, to natural language processing (NLP) module 112, NLP database 114, persona database 116, and content database 118.

User device 104, influencer device 106, and marketer device 108 can be desktop computers, mobile computers, mobile communication devices (e.g., mobile phones, smart phones, tablets), televisions, set-top boxes, and/or any other network enabled device capable of communicating with one or more Internet domains, such as social media networks (not shown). Although user device 102, influencer device 106, and marketer device 108 are illustrated in FIG. 1 for descriptive purposes, persons of ordinary skill in the art will recognize that other categories of devices may communicate with the document processing and management system 110 in accordance with the various embodiments disclosed herein.

User device 102 enables a user to access his or her corresponding social media accounts and otherwise interact with Internet content. User device 102 generates user data in the form of social media profiles; data about which influencers the user follows; posts, likes, and other social media interactions; data consumption patterns; and other online and offline activities. In some embodiments, this user data may be stored and/or aggregated in one or more third-party data sources 120.

Influencer device 106 may be a user device that has access to at least one influencer's user account. Influencer device 106 may generate influencer data in the form of social media profiles; data about which influencers the influencer follows; the influencer's posts, likes, and other social media interactions; social media interactions with the influencer's posts; data consumption patterns; and other online and offline activities. Influencer device 106 may also generate influencer data that describes one or more interests with which the influencer is associated. For example, a particular influencer might be known for social media posts about indie rock bands in the New York City area. In some embodiments, this influencer data may be stored and/or aggregated in one or more third-party data sources 120.

Marketer device 108 may be a user device that has access to the account that advertises a product or service. Marketer device 108 may generate marketing data, such as data in the form of products and services advertised; social media profiles; posts, likes, and other content interactions. Marketer device 108 may also consume persona profiles generated based on the user and influencer data in order to better tailor marketing campaigns to users and influencers who are likely to be interested in the associated products or services. In some embodiments, this influencer data may be stored and/or aggregated in one or more third-party data sources 120.

Document processing and management system 110 is configured to a receive document (e.g. a document describing a marketing campaign) and use NLP module 112 to extract relevant information from the document. For example, in the case of a marketing campaign brief, the relevant information may include a business objective, marketing goal, targeted persona profile, brand name, economic sector, insights and/or causes. The extracted information is stored in a NLP database 114.

Document processing and management system 110 also receives user data from third-party data source(s) 120 that collect and provide access to user data, influencer data, and marketer data (collectively referred to herein as “audience data”), such as Facebook Insights and Google Analytics, for example. Based on this collected audience data, document processing and management system creates at least one persona profile. Document processing and management system 110 stores each persona profile in persona database 116. The audience data used to create the personal profiles may be stored locally within a locally accessible file system of the document processing and management system's network and/or stored remotely with one or more cloud storage servers. This audience data may be stored indefinitely or for some predetermined length of time. Additionally stored audience data may also be overwritten or otherwise amended upon receipt of new audience data.

In some embodiments, document processing and management system 110 can also communicate with one or more content sources, referred to as content database 118. Content database 118 stores content, such as images, videos, music, podcasts, articles, etc., of the type of content users typically interact with. Document processing and management system 110 can store metadata that identifies each content database. For example, the metadata may include a content path that can be used to identify the content database. The content path may include the name of the content database and a folder hierarchy associated with the content database (e.g., the path for storage locally within a user device 102). Document processing and management system 110 may use the content path to present the content databases in the appropriate folder hierarchy in a user interface with a traditional hierarchy view. A content pointer that identifies the location of the content database may also be stored with the content identifier. For example, the content pointer may include the exact storage address of the content database in memory. In some embodiments, the content pointer may point to multiple locations, each of which contains a portion of the content database.

NLP database 114, persona database 117, and content database 118 may be located in one or more network accessible storage devices, in a redundant array of independent disks (RAID), etc. Additionally, these databases may use one or more partition types, such as FAT, FAT32, NTFS, EXT2, EXT3, EXT4, ReiserFS, BTRFS, and so forth.

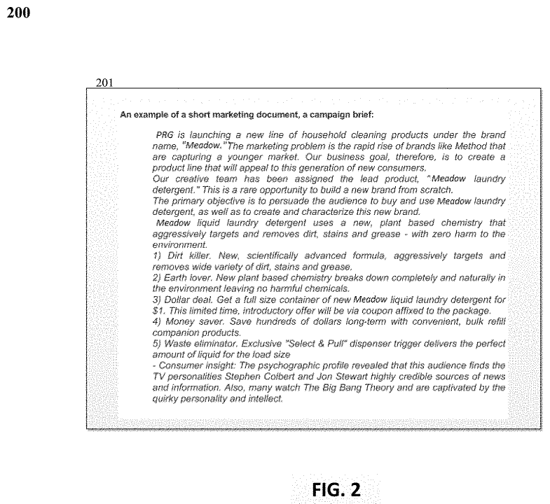

FIG. 2 shows an example of a marketing document for a campaign brief, in accordance with various embodiments. The marketing document can include information related to a new product, a brand name associated with the new product, business goals and/or objectives of the campaign, merits and/or advantages of the new product over other existing products in the market, and consumer insight information pertaining to an identified customer base for the new product.

For example, FIG. 2 shows a marketing document of a campaign brief for a new line of household cleaning products being launched by PRG under a brand name of “Meadow.” A business goal for the “Meadow” brand of cleaning products is to target a younger generation of new consumers by building a new brand from scratch. A primary objective described by the marketing document is to persuade the targeted younger generation to buy and use the new product. The marketing document may provide various insights into why the “Meadow” brand of cleaning products may be better than other products on the market based on information related to their cost effectiveness and environmental friendliness, for example. The marketing document may also provide consumer insight information, such as a psychographic profile of the targeted consumers, that may help target content streams for advertisement and marketing campaigns of the “Meadow” brand of cleaning products.

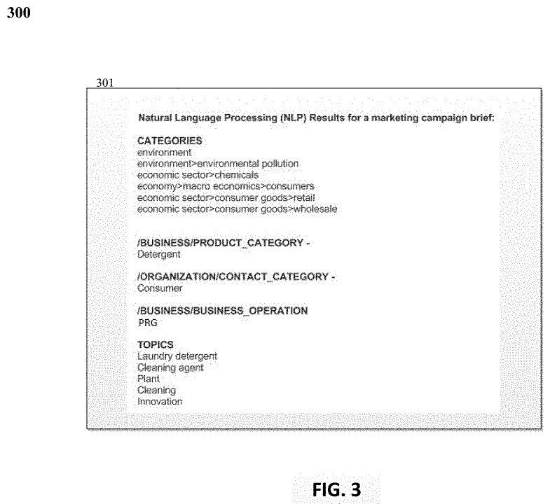

FIG. 3 shows an example of NLP results for the marketing document of the “Meadow” brand of cleaning products. The NLP results after analyzing and processing the marketing document include information related to categories, sub-categories, business, targeted audience, and topics associated with the marketing document. Examples of the categories classification shown in FIG. 3 are environment, economic sector and economy with sub-category examples corresponding to environmental pollution, chemicals, and macro-economics, respectively. The NLP results for the marketing document can include several identified topics, such as laundry detergent, cleaning agent, plant, cleaning and innovation and/or normalized links to websites (e.g., Wikipedia, DBPedia, Wikidata, etc.) that provide additional information associated with the products.

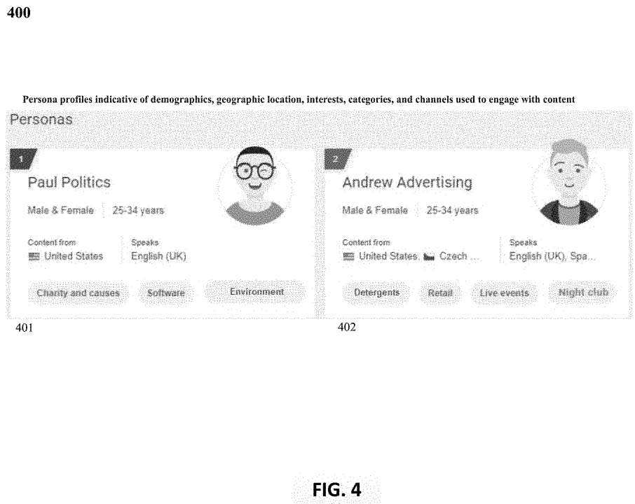

FIG. 4 shows examples of persona profiles 401 and 402 generated by document processing and management system 103, in accordance with various embodiments. Persona profiles 401 and 402 are fictional user profiles that are designed to represent a typical member of a demographic and are characterized by a set of one or more interests. Document processing and management system 103 generates persona profiles based on accessing, identifying, storing, and analyzing audience data. For example, persona profile 401 is generated based on identifying the persona's interest in charities and causes, software and the environment. As another example, persona profile 402 is generated based on identifying the persona's interest an interest in detergents, retail, live events and night clubs.

Document processing and management system 103 can collect audience data from various online sources including third-party data aggregation sources (e.g. Facebook Audience Insights and Google Analytics), social media profiles, websites visited, content subscriptions, and news feeds. For example, information related to a user's demographics that is publicly displayed by the social media profile can be used to determine the user's full name, gender, address, age, education, language, employment status, relationship status, pets, family members, friends, other connected individuals, news feeds, media preferences (e.g. movies, artists, songs and books that have been liked), content interactions, political affiliations, profile photos that include information capable of identifying the user, and causes the user cares about (e.g., wildlife, climate change, environmental protection, endangered species protection and charities).

The generated user persona profiles can include interactive tabs related to each topic of interest and/or each category of items (such as media content items and product items) that can include hierarchically arranged viewable items that respectively correspond to each topic and/or category of items displayed. For example, the persona profiles can include interactive tabs corresponding to charities, causes, environment, advertising, live events, software, detergents, retail, subscriptions and news feeds. The interactive tabs can then be matched to topics and/or categories of a marketing campaign to identify persona profiles that are most likely to support and/or show interest in the marketing campaign.

As noted above, the interests associated with the generated user persona profiles may be based on data obtained from Facebook Audience Insights, Google Analytics, content these users engaged with, and/or other third-party audience data sources. The data obtained from Facebook Audience Insights may correspond to reactions from unique users to content published on a targeted Facebook page during a predefined date range. In some instances, only visible Facebook page content may be taken into account. Google Analytics may include information related to unique users that have visited a website of interest at least once during a predefined date range.

In some embodiments, data from Facebook Audience Insights, Google Analytics, and/or another data source may be used by document processing and management system 103 to generate persona profiles. In some embodiments, the document processing and management system 103 may use a service such as Facebook Insights to obtain publically available demographic data. The Facebook Audience Insights data (e.g. Storytellers) may be indicative of users that are active on a Facebook Page of interest. The data may also include information related to page likes, posts on the page timeline, commenting on, or sharing one of the posts of page, answering a question posted and/or RSVPing to an event posted on the page.

Such data sources often use different taxonomies of interests that can be mined and/or cross-correlated to better deduce the interests attributed to each persona profile. For example, document processing and management system 103 can pair affinity categories of Google Analytics with Facebook Interests to determine the interests of users. In a further example, a user's interests are deduced from data associated with content the user engaged with and/or pages that the user visits or likes and/or influencers with whom the user interacted. This technique may involve identifying and analyzing a tag that defines a topic of content associated with the page or influencer. An internal taxonomy of topics, translated into Facebook Interests, may then be used to assign the interests to the persona profiles. A field in the persona profile reflecting the persona's interests is then populated as an aggregation of data based on the data of individual social media profile users.

In some embodiments, the interests populated for a particular persona profile are determined using the following procedure. Initially, document processing and management system 103 can receive (A) a distribution of interests in viewers of a particular social media profile (e.g. an influencer's social media profile or the social media profile for a product, service, or other item of interest) or web page and (B) a similar distribution of interests of the users on a related social network. Document processing and management system 103 can then calculate differences between the (A) and/or (B) distributions and generate typical interests associated with the viewers of the given social media profile. This information may be used to form a basis for a general persona. The remaining interests that do not intersect between the (A) and (B) distributions may be removed from consideration.

In some embodiments, typical interests can be sorted based on how unique they are for the viewers of the social media profile or the targeted viewers. For example, an interest that is common to among viewers of a particular social media profile but relatively uncommon outside those viewers can be rated more highly than interests that are either less common among the viewers of the particular social media profile and/or more common among other users. Typical interests for an audience—and thus the interests that are incorporated into a persona profile—are those interests which are unique for a particular audience. Accordingly, typical interests are not simply the most frequent (common) interests for viewers of a particular social network page or web page. Rather, they are interests that distinguish the audience of one persona profile from the audience of other persona profiles.

The resulting interests can then be clustered together. For example, if two interests co-occur in at least 50% of the cases, they can be grouped together. As another example, if the personas are built from multiple platforms, then only the interests that are similar on all the platforms may be grouped together. For example, it may happen that interest in the environment overlaps to a large extent with interest in global warming. In that case, those two interests may be clustered together. The coverage of a constructed persona profile can therefore be expanded while the common topic of the viewers the persona profile represents can be kept intact. When clusters are merged between social networks, the score of each interest can be calculated as a maximum of the scores of the interest on each social network. The largest score of the interest is picked in each cluster and can be used to sort all the clusters from the largest to the smallest. The top 3 clusters of interests are picked as a basis for the 3 personas shown in the product Therefore, the clusters of interests that are most typical for a given targeted viewer base are emphasized.

A persona profile may also include a typical age range gender for an identified audience. Information related to age and/or gender associated with a social media profile may be deduced from collected audience data. For example, in the case of Google Analytics, age and gender identifications that are directly available in the Google Analytics data may be used. In case of a platform such as Facebook Audience Insights, the probability of age and gender category for each user can be estimated. The probability is estimated based on a model that takes into account all pages that a user interacted with along with the Facebook Insights metric known as Storytellers. Thus, the age and/or gender determined for a persona profile is an aggregation of data for users that match the criteria of this persona.

Each persona profile may also include the persona's country and language. In the case of Google Analytics data, the Location and Language aspects of the users metric may be used. On the other hand, for Facebook Audience Insights, document processing and management system 103 takes into account the location and language of the posts (and pages publishing the posts).

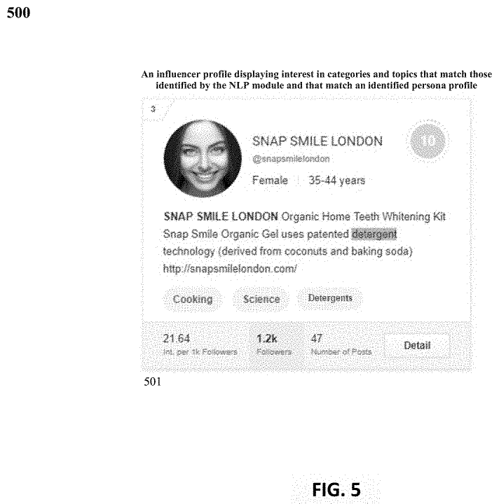

FIG. 5 shows an exemplary influencer profile 501, identified by the document processing and management system 103 as a match between a particular persona profile and influencer data associated with the influencer. The influencer data can be collected from various online and offline sources such as those described above for collecting the user data. Example of online sources of influencer data include social media profiles, websites visited, subscriptions, and news feeds. Publicly displayed information on the influencer's social media profile can be used to determine the influencer's full name, gender, number of followers, number of posts, number of views corresponding to the posts, interactions per follower, an influence rank, address, age, education, language, employment status, relationship status, pets, family members, friends, other connected individuals, news feeds, media preferences (e.g., movies, artists, songs and books that have been liked), content interactions, political affiliations, profile photos that include information capable of identifying the user, hashtags and/or mentions used by the influencers, sponsored content posted by the influencers, and causes the influencer cares about (e.g., wildlife, climate change, environmental protection, endangered species protection and charities). The identified influencer profile can include interactive tabs related to each topic of interest and/or each category of items (such as media content items and product items) that can include hierarchically arranged viewable items that respectively correspond to each topic and/or category of items displayed. For example, the influencer persona profile can include interactive tabs corresponding to cooking and science as shown in FIG. 5. In some embodiments, the influencer persona profile can include hashtags that are indicative of their interests.

The influencer data can be stored in an influencer database that can include several million publicly available profiles. Hundreds of millions of active social media profiles can be analyzed to generate and build-up the influencer database. Influencers may be distinguished from ordinary users on the basis of how many users follower the influencer and/or engage with the published content. For example, users with more than 1000 followers may be considered influencers.

The document processing and management system 103 can identify a post published by the influencer that is related to the marketing campaign by matching specific keywords in the post with topics and/or categories of the marketing campaign. For example, the influencer persona profile illustrated in FIG. 5 displays a post related to a teeth whitening kit. A highlighted keyword “detergent” and interest in a category of products related to “detergents,” shown in the post in FIG. 5, matches the detergent “Business/Product Category” of the marketing campaign of the “Meadow” brand of laundry detergent described earlier in FIG. 3. The document processing and management system 103 identifies this match and determines that the influencer profile is a candidate for tracking how viewers are interacting with and/or are influenced by published posts. The posts may be promotional and/or advertisement related posts for consumables, electronics, retail merchandise, venues, and live events. The posts can be related to content items that the influencer likes, recommends, interacts with (e.g., shared with contacts, viewed at least a few times and marked as a favorite) and/or comments on.

By estimating reach, influence and/or interaction of viewers with an influencer's posts, document processing and management system 103 can determine a rank for the influencer. For example, a rank for the influencer of FIG. 5 can be estimated to be “10” based on a degree of relevance of the influencer's posts and/or interests to the marketing campaign of the “Meadow” brand of laundry detergent. The rank can be modified depending upon the product being marketed by the campaign and a match score of the influencer's interests with the product being marketed. For example, if the influencer cares about organic products and publishes posts that promote organic products, the document processing and management system 103 can assign the influencer a higher match score for campaigns affiliated with organic products and a lower match score for campaigns that do not align well with such preferences. As a result, the rank assigned to the influencer for campaigns affiliated with organic products can be higher than those that are not affiliated with organic products.

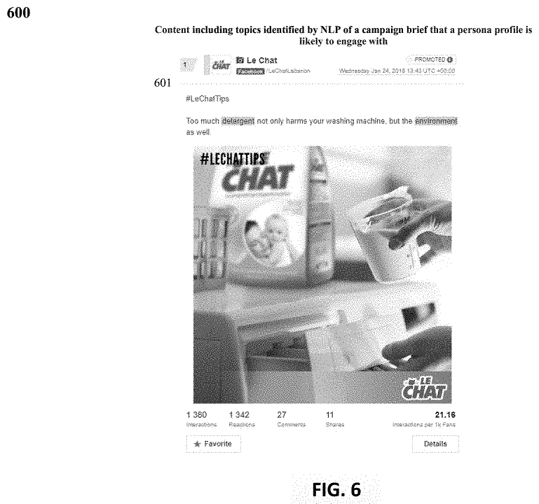

FIG. 6 shows an example of an identified content item that includes keywords that align with the marketing campaign's topics and/or categories and are determined to be of interest to a selected persona profile. The content item may also include several metrics indicative of its relevance to an audience. The metrics can include the number of people who interacted with the content, the number of comments people posted, the sentiment of the comments, the number or type of reaction people users, the number of people who shared the content with others, or unique performance metrics that can indicate on the ration between the number of people who saw the content versus the number of people who interacted with it (e.g. number of interaction per 1000 people). By matching content items to interests of a persona profile, and considering the associated metrics, the document processing and management system 103 can increase a likelihood of the persona interacting with the matched content items via social media and thereby, significantly increase reach, number of viewers, comments, likes, shares and/or other interactions with the matched content items. This can in turn lead to increased sales and interest in the matched content items that the marketing campaign intends to promote. In some embodiments, by matching content items to interests of user's persona profile, the document processing and management system 103 can increase a likelihood of the user buying the product being promoted by an Influencer. The matched content items may be presented to users and/or influencers via advertisements, promotional feeds and/or targeted feeds on their corresponding social media profiles.

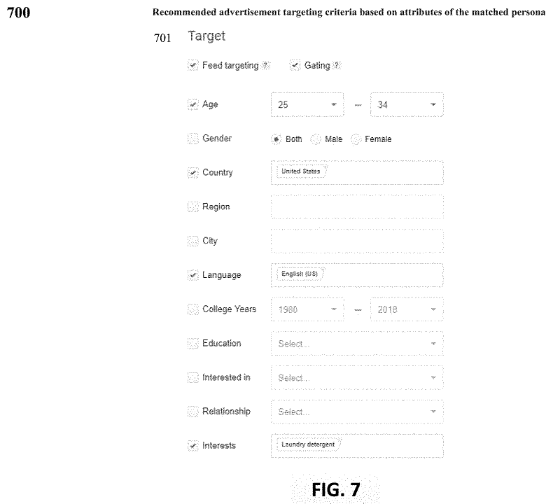

FIG. 7 shows an example of recommended advertisement targeting criteria based on user data for a selected user persona profile that matches topics/or categories of the campaign as described in FIGS. 2-4 above. For example, interests and demographics related to age, location and language are seen to match the recommended targeting criteria of advertisements related to the laundry detergent campaign. Other selectable options for the advertisement targeting criteria can be related to feed targeting and gating, wherein advertisements may be included as part of targeted feeds to the selected user persona profiles and gating may be included to enable viewing of the advertisement after the selected user persona profile has interacted favorably with certain aspects of the marketing campaign. For example, if the selected user persona profile has liked one of the products of the marketing campaign, then the advertisement will be presented to the selected user persona profile, otherwise the advertisement will not be presented.

In some embodiments, the document processing and management system 103 may determine that a threshold number of criteria need to be met for the advertisement to match targeted user persona profiles. In some embodiments, certain criteria can be assigned higher weighting scores that can be combined to generate the match score. For example, location country and/or age may be assigned a higher weight than the relationship status. In some examples, the document processing and management system 103 may determine that at least three criteria need to be met for presenting the advertisement to a user persona profile. The location country may be determined based on analyzing location tags associated with published posts on social media profiles and/or information determined from the social media profiles. All languages used by users and influencers are used to generate the user persona profiles and the influencer persona profiles. For example, for Facebook®, location and language of posts and/or pages publishing the posts are taken into account for determining which social media profiles interacted with the posts and/or pages publishing the posts. This information can then be used for determining a language and location of a user persona profile or influencer persona profile. As another example, Google Analytics Data includes user metrics data that is indicative of location and/or language associated with the social media profile.

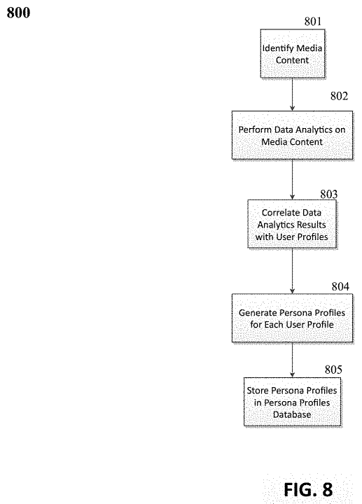

FIG. 8 shows a flowchart for generating user persona profiles. The user persona profiles may be generated based on collecting information from various online and offline sources related to users as described with respect to FIGS. 4-5 earlier. In step 801, the system can identify content from the online and offline sources that a user has engaged with. The system can also identify influencers that the user follows and/or interacts with through the online and offline sources. In step 802, the system can perform data analytics on the identified content that the user interacts with. The data analytics results can include results from other data analytics platforms such as (e.g. Facebook Audience Insights and Google Analytics). In step 803, the system can correlate and/or assign the data analytics results to the corresponding user and then, in step 804, generate the respective user persona profile based on the identified media content and the data analytics results. The generated user persona profiles can be stored in a database, in step 805, by the document processing and management system 110. For example, the generated user persona profiles along with topics of interest and categories of items posted are indexed and stored. The generated user persona profiles can include one or more attributes that can be used to search for content, influencers and/or enhance the ad targeting criteria shown in FIG. 7.

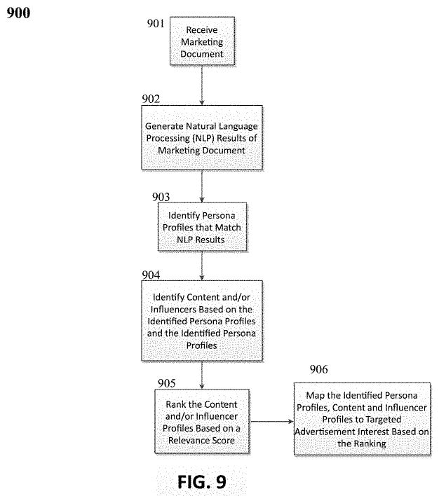

FIG. 9 shows a flowchart for processing and analyzing a marketing document (e.g., the marketing document shown in FIG. 2). At step 901, a document processing and management system (e.g. document processing and management system 110 of FIG. 1) can receive one or more marketing documents related to a campaign in step 901. At step 902, the document processing and management system performs NLP of the one or more marketing documents to generate NLP results of the marketing documents that can be based on topic extraction, identification of categories and/or sub-categories of content of the marketing documents. In some embodiments the NLP results may include demographics and/or geographic data identified from the marketing document. The topics, categories and sub-categories may be hierarchically arranged depending upon a business objective, marketing goal, targeted persona profile, brand name, economy, economic sector, insights and/or causes that can be extracted from the marketing document. The results of the NLP can be stored in a NLP results database for future retrieval and further processing. In other embodiments, the NLP results might be translated into different languages and/or converted into equivalent terms using a dictionary related to a specific media (e.g. terms most often used over social media and/or terms often used over instant messaging).

At step 903, the document processing and management system can use the NLP results and the persona profiles stored in the persona profiles database, as described earlier with respect to FIG. 8, to identify user persona profiles that best match the topics, categories and/or sub-categories associated with the marketing documents and/or the translated or converted results. The NLP results can be used to determine a match score for each persona profile based on a number of criteria and/or attributes that matched. For example, the match score may be based on the number of advertisement targeting criteria that matched based on attributes of the persona profile as described earlier in FIG. 7.

In some embodiments, the NLP results can be used to assign weights to the criteria and/or attributes so that some criteria are essential for the persona profile to match the topics, categories and/or sub-categories of the campaign. For example, location and interests of the persona profile may be assigned higher weights than education or relationship status of the persona profile.

At step 904, the document processing and management system can search for content and/or influencer data from various online and offline sources, and/or from a content and influencer database, to identify content and/or influencers that match the topics, categories and/or sub-categories of the campaign. The identified content and/or influencers can also match one or more interests of the identified persona profiles of step 903.

For example, media items can be analyzed to identify that they are associated with the keyword “detergent.” Such media items may be grouped together and stored under a category related to the keyword “detergent.” Another example may relate to a location associated with the persona shown in FIG. 4 to identify an influencer or enhance the targeting criteria showing on FIG. 7. In some embodiments the metrics associated with the content, as described with respect to FIG. 6 can be used to identify content that provides better performance (e.g. drives more engagement and/or is deemed more relevant) with the identified persona. The document processing and management system 103 can then match content items with interests associated with the identified persona profiles.

In some embodiments the metrics associated with the content, as described with respect to FIG. 6. can be used to identify content that better performs (e.g. more relevant, drives more engagement) with the identified persona profile. The matched content items can then be presented to users associated with the persona profiles via advertisements, promotional feeds and/or targeted feeds on the corresponding social media profiles as described earlier with respect to FIG. 6. This approach enables improved efficiency of marketing campaigns by providing users with content items and promotions related to products that the users are interested in. The methods and systems described above have the potential to improve the overall customer experience, the sales of products and other content items being promoted by the marketing campaign.

The document processing and management system can match the identified Influencer profile with interests associated with the identified user persona profiles of step 903. In some embodiments the metrics associated with the influencer, as described with respect to FIG. 5, may also be used to identify an Influencer profile that performs better (e.g. more relevant, drives more engagement) with the identified persona profile. The matched Influencer profile can then be used to present content to users associated with the persona profiles via advertisements, promotional feeds and/or targeted feeds on the corresponding social media profiles as described earlier with respect to FIG. 5.

In step 906, the metrics associated with the Influencer profile and the content can be used to determine a relevance score and then rank the content items and the influencer profiles based on a degree of relevance and/or match factor. By ranking the most relevant content items and influencer profiles that a user is likely to engage with, and that matches the topic and/or category of the marketing campaign, the system is able to map the identified user persona profiles, content and influencer profiles to targeted advertisement interests, as in step 907. This approach enables improved efficiency of marketing campaigns by providing users with content items and promotions related to products that the users are interested in by leveraging profiles of Influencers they follow or engage with. The methods and systems described above have the potential to improve the overall customer experience, the sales of products and other content items being promoted by the marketing campaign.

Exemplary Systems

In exemplary embodiments of the present invention, any suitable programming language may be used to implement the routines of particular embodiments including C, C++, Java, JavaScript, Python, Ruby, CoffeeScript, assembly language, etc. Different programming techniques may be employed such as procedural or object oriented. The routines may execute on a single processing device or multiple processors. Although the steps, operations, or computations may be presented in a specific order, this order may be changed in different particular embodiments. In some particular embodiments, multiple steps shown as sequential in this specification may be performed at the same time

Particular embodiments may be implemented in a computer-readable storage device or non-transitory computer readable medium for use by or in connection with the instruction execution system, apparatus, system, or device. Particular embodiments may be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments may be achieved by any means as is known in the art. Distributed, networked systems, components, and/or circuits may be used. Communication, or transfer, of data may be wired, wireless, or by any other means. Alternatively, semi-automatic and/or manual methods are also within the scope of the invention.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that may be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods for providing a user interface to a user capable of a set of interactivity features in a variety of operational modes, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

1. A method for processing a marketing document for directing a marketing campaign, comprising:
receiving, by a computing device, a marketing document;
generating, by the computing device and based on analyzing the marketing document using natural language processing (NLP), NLP marketing results indicative of at least one campaign topic associated with the marketing document and at least one category associated with the campaign;
querying, by the computing device, a database of one or more user persona profiles for profiles that match the at least one campaign topic or the at least one category associated with the campaign; and
ranking, by the computing device and based on a match score, a subset of the one or more user persona profiles that match the at least one campaign topic or the at least one category.

2. The method of claim 1, wherein the one or more user persona profiles are stored in a persona profiles database, and wherein each of the one or more user persona profiles are indicative of one or more interests, a geographic location of the corresponding user, and a gender of the corresponding user.

3. The method of claim 2, further comprising:
determining, based on querying the persona profiles database, a geographic region associated with the subset of the one or more user persona profiles;
identifying, based on analyzing the content items, at least one industry associated with the geographic region; and
generating, based on the ranking of the subset of the one or more user persona profiles and the at least one industry, an advertisement price and advertisement performance metric associated with the at least one campaign topic

4. The method of claim 2, wherein each of the one or more user persona profiles are indicative of at least one of:
an age range;
at least one language;
at least one recently viewed media channel, and
at least one content engagement time indicative of when at least one content item was accessed.

5. The method of claim 4, further comprising:
identifying, based on querying the persona profiles database and based on the subset of the one or more user persona profiles, a preferred day of week and a preferred hour of the day during which a respective user associated with a user profile of the subset of the one or more user persona profiles engages with the content items.

6. The method of claim 1, wherein the querying the database of the one or more user persona profiles for profiles that match the at least one campaign topic or the at least one category further comprises:
identifying a plurality of interests respectively corresponding to each of the one or more user persona profiles; and
mapping each of the plurality of interests to a respective targeted advertising interest.

7. The method of claim 6, wherein the targeted advertising interest is indicative of attributes of an advertisement that increase a relevance of the advertisement to:
the respective user persona profile, and
to the at least one category associated with the campaign or the at least one campaign topic.

8. The method of claim 7, wherein the targeted advertising interest is indicative of relevant media channels for hosting the advertisement.

9. The method of claim 1, further comprising:
identifying influencer profiles that the subset of the one or more user persona profiles are associated with via social media networks based on one or more topics of interest that match the at least one campaign topic or the at least one category.

10. The method of claim 9, further comprising:
ranking, based on a relevance score to the at least one campaign topic or the at least one category, the influencer profiles.

11. The method of claim 10, further comprising:
using the ranking to select a subset of the influencer profiles; and
directing targeted advertising to the subset of the influencer profiles based on the ranking.

12. A method for processing a marketing document for directing a marketing campaign, comprising:
generating, by a computing device and based on analyzing a marketing document using natural language processing (NLP), at least one campaign topic and at least one category related to the marketing document;
identifying, by the computing device and based on accessing a user persona profiles database, one or more user persona profiles that match the at least one campaign topic or the at least one category;
assigning, by the computing device and based on a relevance of the at least one campaign topic and the at least one category to one or more influencer profiles, a respective relevance score to each of the one or more influencer profiles; and
mapping, by the computing device, the one or more user persona profiles to a subset of the one or more influencer profiles that have a high relevance score and to targeted advertisement interests.

13. The method of claim 12, wherein the mapping the one or more user persona profiles to the subset of the one or more influencer profiles and to the targeted advertisement interests is based on:
ranking, by the computing device and based on the respective relevance score, each influencer profile of the subset of the one or more influencer profiles that match the at least one campaign topic or the at least one category.

14. The method of claim 13, wherein the targeted advertising interests are indicative of relevant media channels for hosting the advertisement.

15. The method of claim 12, wherein the mapping the one or more user persona profiles to the targeted advertisement interests further comprises:
identifying a plurality of interests respectively corresponding to each user persona profile; and
mapping each of the plurality of interests to a respective targeted advertising interest.

16. The method of claim 15, wherein the respective targeted advertising interest is indicative of attributes of an advertisement that increase a relevance of the advertisement to:
the respective user persona profile, and
to the at least one category associated with the at least one campaign topic and the at least one category related to the marketing document.

17. The method of claim 12, further comprising:
storing, by the computing device, the one or more user persona profiles in a persona profiles database, wherein each of the one or more user persona profiles are indicative of one or more interests, a geographic location of the corresponding user, and a gender of the corresponding user.

18. The method of claim 17, further comprising:
determining, based on querying the user persona profiles database, a geographic region associated with the one or more user persona profiles;
identifying, based on analyzing the content items, at least one industry associated with the geographic region; and
generating, based on the at least one industry and ranking the one or more user persona profiles, an advertisement price and advertisement performance metric associated with the at least one campaign topic.

19. A method for generating persona profiles, comprising:
identifying, by a computing device, content items that a user has engaged with;
performing, by the computing device, data analytics on the content items,
generating, by the computing device and based on the data analytics, at least one interest and one or more attributes related to the user; and
generating, by the computing device and based on the at least one interest and one or more attributes, a user persona profiles corresponding to the user.

20. The method of claim 19, wherein the performing the data analytics on the content items comprises analyzing content on social media networks that the user has interacted with.
